(19) United States
(12) Patent Application Publication
(10) Pub. No.: US 2010/0188360 A1
(43) Pub. Date: Jul. 29, 2010

(54) ELECTRONIC DEVICE AND METHOD OF ARRANGING TOUCH PANEL THEREOF

(75) Inventors: Chul-Yong Joung, Yongin-si (KR); Bang-Won Lee, Yongin-si (KR)

Correspondence Address: CANTOR COLBURN, LLP, 20 Church Street, 22nd Floor, Hartford, CT, 06103, US

(73) Assignee: ATLab INC., Yongin-si (KR)

(21) Appl. No.: 12/445,653

(22) PCT Filed: Jun. 7, 2007
(86) PCT No.: PCT/KR07/02760

§ 371 Date: Apr. 15, 2009

(30) Foreign Application Priority Data
Oct. 16, 2006 (KR) 10-2006-0100370

(51) Int. Cl. G06F 3/045

(52) U.S. Cl. 345/174

(57) ABSTRACT

Provided are an electronic device and a method of arranging a touch panel thereof. The electronic device includes: a display panel for displaying an image; a touch panel including a cover and a plurality of electrodes adhered to the cover; and a sensing unit including a plurality of digital contact controllers for detecting delays caused by variations of capacitances of the electrodes to output digital data signals. Thus, the electronic device includes an economical touch panel that can be variously applied according to users' convenience or purpose without using an expensive substrate having the entire surface coated with an ITO layer.

### TECHNICAL FIELD

The present invention relates to an electronic device, and more particularly, to an electronic device including a touch panel disposed outside a display unit of a display panel and a method of arranging the touch panel of the electronic device.

### BACKGROUND ART

A touch panel is a computer peripheral device that is installed on a display surface of a display device, such as a cathode ray tube (CRT), a liquid crystal display (LCD), a field emission display (FED), a plasma display panel (PDP), and an electroluminescence device (ELD). The touch panel allows a user to press the touchpad while seeing the display device, and to input preset information to a computer.

FIG. 1 is a schematic construction diagram of a display system including a touch panel disposed on a display surface of a conventional LCD (Liquid Crystal Display) device.

Referring to FIG. 1, a touch panel 10, a liquid crystal display (LCD) panel 20, and a backlight unit 30 are separately provided. The touch panel 10 includes an electrode and is contacted by a user. The LCD panel 20 displays an image in response to operation of the touch panel 10. The backlight unit 30 irradiates light to the LCD panel 20. The touch panel 10 is connected to a touch panel controller 50 by a signal line 40 and the touch panel controller 50 is connected to a computer main body 60 in order to operate according to a state of contact of the touch panel 10.

When the touch panel 10 is contacted by the user under a predetermined pressure or higher or by a resistance material to perform a desired operation, a pressure sensor or a touch sensor detects a variation of resistance or voltage in a contacted position, and the touch panel controller 50 recognizes the coordinates of the contacted position, transmits the coordinates of the contacted position to the computer main body 60, and displays information corresponding to the coordinates on the LCD panel 20.

Referring to FIG. 2, which is a cross-sectional view of the touch panel 10 shown in FIG. 1, the touch panel 10 includes an upper substrate 11, an upper transparent electrode 12 disposed on one surface of the upper substrate 11, a lower substrate 13, and a lower transparent electrode 14 disposed on one surface of the lower substrate 13 opposite the upper transparent electrode 12. A conductive X-axis pattern 16 is disposed on an edge of the upper transparent electrode 12, and a conductive Y-axis pattern 15 is disposed on an edge of the lower transparent electrode 14. The upper X-axis pattern 16 is electrically isolated from the lower Y-axis pattern 15 by an insulator 17.

The upper substrate 11 having the upper transparent electrode 12 is adhered to the lower substrate 13 having the lower transparent electrode 14 using the insulator 17 serving as an adhesive.

A plurality of dot spacers 18 are installed between the upper and lower transparent electrodes 12 and 14. An appropriate gap is maintained between the upper and lower transparent electrodes 12 and 14 by the dot spacers 18. A very small gap of about 50 μm or less is maintained between the upper and lower transparent electrodes 12 and 14 by the dot spacers 18.

The upper substrate 11, which can, for example, be pressed by a pen or a finger, may be typically a transparent film formed of, for example, polyethylene terephthalate (PET), and the lower substrate 13 may be a transparent film formed of the same material as the upper substrate 11, a glass substrate, or a plastic substrate. The upper and lower transparent electrodes 12 and 14 formed on surfaces of the upper and lower substrates 11 and 13 may be formed of indium tin oxide (ITO), indium zinc oxide (IZO), or indium tin zinc oxide (ITZO).

The formation of a transparent electrode is problematic in that patterns cannot be printed on the transparent electrode. Since the transparent electrode is poorly adhered to a glass substrate, when patterns are printed on the transparent electrode, edges become irregular so that straightness required for the construction of an electrode cannot be fulfilled. In order to overcome this drawback, the transparent electrode is formed by coating an ITO layer on the entire surface of the upper substrate 11 and patterning the ITO layer using a photolithography process.

Unlike other function layers, such as an electrode and an insulator, which can be formed using a printing process that is a thick layer forming process, the ITO transparent electrode is formed only using a photolithography process that is a thin layer forming process, thereby greatly increasing the production cost.

Also, since coating the ITO layer to a uniform thickness on the entire surface of the upper substrate 11 is difficult in terms of practical use, an expensive substrate having an ITO layer is inevitably purchased and employed.

### DISCLOSURE

### Technical Problem

The present invention is directed to an electronic device including a touch panel in which an electrode is disposed outside a display surface of a display panel.

Also, the present invention is directed to a method of arranging a touch panel on an electronic device.

### Technical Solution

One aspect of the present invention provides an electronic device including: a display panel for displaying an image; and a touch panel including a cover and a plurality of electrodes adhered to the cover.

The electronic device may further include a sensing unit having a plurality of digital contact controllers that detect delays caused by variations of electrostatic capacitances of the plurality of electrodes to output digital data signals.

The display panel may include: a display unit on which the image is displayed; a driver for externally receiving an image signal to drive the image signal on the display unit; a light source disposed on a rear surface of the display unit to irradiate light; and a light diffuser for receiving the light from the light source to uniformly diffuse the light toward the display unit.

The cover may include a plurality of nonconductive opaque regions disposed under edges thereof, and the electrodes may be disposed under the opaque regions to detect states of contact.

The electrodes adhered to the cover may be interposed between the cover and the display panel.

The electrodes adhered to the cover may be aligned with the cover in a shape, position, and size corresponding to the shape, position, and size of a screen displayed on the display unit of the display panel.

The electrodes adhered to the cover may include transparent electrodes, opaque electrodes, or semitransparent electrodes.

The light diffuser may include at least one metal plate that is used as an electrode.

The sensing unit may comprise a plurality of digital contact controllers and may detect whether or not the electrodes are contacted by a finger or an object and the direction and intensity of a pressure applied to the electrodes.

Each of the digital contact controllers may detect a delay caused by variation of an inductive capacitance, an electrostatic capacitance, and a resistance to output digital data.

Each of the digital contact controllers may include: a delay variable unit for generating a sensing signal having a delay time that varies with a reference signal having a fixed delay time and the impedance of an externally applied signal; and a delay calculating and data generating unit for calculating a delay difference between the reference signal and the sensing signal to generate digital data corresponding to the delay difference.

The delay variable unit may include: a measurement signal generator for generating a measurement signal; a fixed delay for delaying the measurement signal by a predetermined time to generate the reference signal; and a variable delay for varying a delay time in response to the impedance of the externally applied signal and delaying the measurement signal by the varied delay time to generate the sensing signal.

Another aspect of the present invention provides a method of arranging a touch panel of an electronic device including a display panel having a display unit on which an image is displayed. The method includes: arranging a cover on the display unit; and arranging a plurality of electrodes on one surface of the cover.

The cover may include a plurality of nonconductive opaque regions disposed under edges thereof, and the electrodes may be disposed under the opaque regions.

The electrodes may be adhered to the cover and interposed between the cover and the display panel.

The electrodes adhered to the cover may be aligned with the cover in a shape, position, and size corresponding to the shape, position, and size of a screen displayed on the display unit of the display panel.

The electrodes adhered to the cover may include transparent electrodes, opaque electrodes, or semitransparent electrodes.

The entire cover may be divided into a predetermined number of regions, and at least one of the electrodes adhered to the cover may be disposed in each of the predetermined number of regions of the cover.

### Advantageous Effects

As described above, a touch panel using an electrode according to the present invention may be disposed under a cover, in a display panel, or under a nonconductive opaque region. The touch panel may include transparent electrodes, opaque electrodes, or semitransparent electrodes.

Therefore, an electronic device according to the present invention may include an economical touch panel that can be variously employed according to a users' convenience or purpose without using an expensive substrate having the entire surface coated with an indium tin oxide (ITO) layer.

### DESCRIPTION OF DRAWINGS

FIG. 1 is a schematic construction diagram of a display system including a touch panel disposed on a display surface of a conventional liquid crystal display (LCD);

FIG. 2 is a cross-sectional view of the touch panel shown in FIG. 1;

FIG. 3 is a cross-sectional view of an electronic device including a touch panel according to an exemplary embodiment of the present invention;

FIG. 4 is a plan view of the electronic device including the touch panel shown in FIG. 3;

FIG. 5 is a diagram illustrating a method of detecting a state of contact of an electrode according to the present invention;

FIG. 6 is a block diagram of a digital contact controller included in a sensing unit according to the present invention;

FIGS. 7 and 8 are a cross-sectional view and a plan view of an electronic device including a touch panel according to another exemplary embodiment of the present invention, respectively;

FIGS. 9 and 10 are plan views of an electronic device including a touch panel according to yet another exemplary embodiment of the present invention;

FIG. 11 is a plan view of an electronic device including a touch panel according to still another exemplary embodiment of the present invention; and

FIG. 12 is a cross-sectional view of an electronic device including a touch panel according to still yet another exemplary embodiment of the present invention.

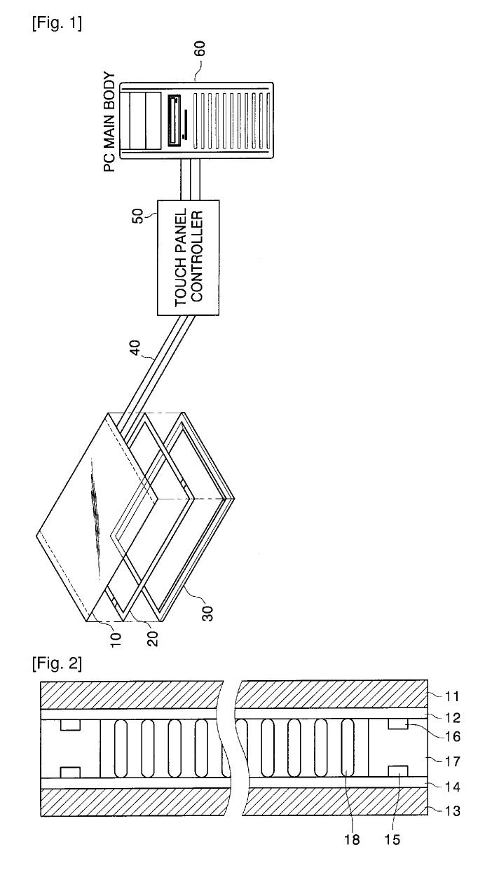

### MODE FOR INVENTION

Hereinafter, an electronic device and a method of arranging a touchpad thereof according to exemplary embodiments of the present invention will be described in detail.

While a conventional touch panel has an electrode disposed over a display device, a touchpad according to the present invention has an electrode disposed under a plate forming a cover of an electronic device or in other positions.

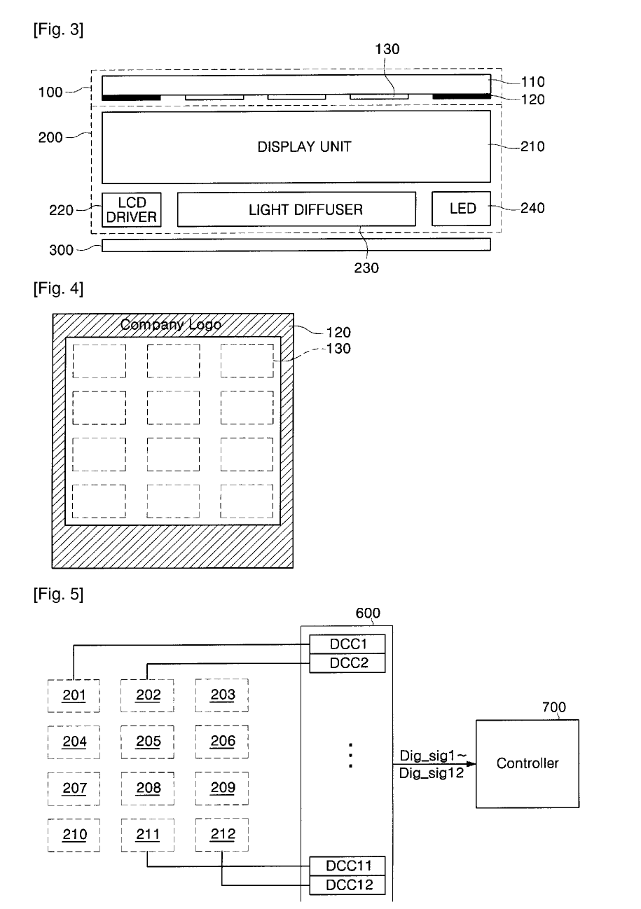

FIGS. 3 and 4 are a cross-sectional view and a plan view of an example in which electrodes according to the present invention are disposed under a cover of a cellular phone, and FIG. 5 is a diagram illustrating a method of detecting a state of contact of an electrode according to the present invention.

FIG. 3 is a cross-sectional view of an electronic device in which electrodes are disposed under a cover according to an exemplary embodiment of the present invention.

Referring to FIG. 3, the cellular phone includes a touch panel 100, a display panel 200 disposed under the touch panel 100 to display an image, and a circuit board 300 disposed under the display panel 200 to connect a circuit of the display panel 200 to an internal circuit of a main body of the cellular phone.

The touch panel 100 includes a cover 110 and a plurality of electrodes 130 disposed under the cover 110. An opaque region 120 formed of a nonconductive material is disposed on both edges of the cover 100 to prevent internal units of the display panel 200 from being exposed.

The display panel 200 includes a display unit 210 disposed under the touch panel 100 to display an image, a driver 220 disposed under the display unit 210 to externally receive an image signal and drive the image signal, a light source 240 for irradiating light, and a light diffuser 230 for receiving light from the light source 240 to uniformly diffuse the light toward the display unit 210.

The electrodes 130 included in the touch panel 100 are provided in a shape, size, and position corresponding to the shape, size, and position of a screen of the display unit 210 of the display panel 200.

Also, the electrodes 130 may be formed of one selected from the group consisting of a transparent material, an opaque material, and a semitransparent material for the convenience or purpose of users.

FIG. 4 is a plan view of the cellular phone shown in FIG. 3.

The opaque region 120 is formed of a nonconductive insulating material, such as plastic or non-transparent coating. Typically, a company logo is attached to the opaque region 120. Each of twelve rectangles illustrated with dotted lines refers to the electrode 130 disposed under the cover 110 of the cellular phone. The electrodes 130 are constructed in a shape and position corresponding to the shape and position of the screen displayed on the display unit 210 of the display panel 200. In the present invention, the twelve rectangles refer to the electrodes 130 disposed under number press pads corresponding to 1 to 9, *, 0, and #, respectively.

When a user sees the screen of the display unit 210 of the display panel 200 and presses the cover 110 using a finger or an object to perform a desired operation, the finger or object comes into contact with the electrodes 130 disposed under the cover 110 and thus, the display unit 210 of the display panel 200 performs the corresponding function.

FIG. 5 is a diagram illustrating a method of detecting a state of contact of the electrode described with reference to FIGS. 3 and 4. Referring to FIG. 5, a plurality of electrodes 201 to 212, which underlie the cover 110, are disposed in the cellular phone and connected to a sensing unit 600. The sensing unit 600 includes a plurality of digital contact controllers DCC1 to DCC12, which detect states of contact and correspond to the electrodes 201 to 212, respectively.

A digital contact controller (DCC) is a technique that is disclosed in Korean Patent Publication No. 10-2005-0115170. According to the technique, the DCC is characterized by sensing a delay caused by variations of an inductive capacitance, an electrostatic capacitance, and a resistance, and an external touch object may not be a resistive object, such as a finger.

Sensing terminals of the digital contact controllers DCC1 to DCC12 detect states of contacts and output a plurality of digital data Dig sig1 to Dig sig12, respectively, and a controller 700 receives the respective digital data Dig sig1 to Dig sig12, performs operations corresponding to the digital data Dig sig1 to Dig sig12, and displays the result on a display unit (not shown) of the display panel.

When the display unit 210 of the display panel 200 is grounded to prevent the occurrence of electromagnetic interference (EMI) due to the driver 220, the operation of the display panel 200 does not affect the electrodes 130 that are contacted by the finger or object. Thus, the electrodes 130 are arranged on the cover 110 at regular intervals only to prevent the electrodes 130 from being grounded or short-circuited or not to excessively increase the electrostatic capacitance.

When a top surface of the display panel 200 is not grounded, a distance between the electrodes 130 and the display panel 200 may be increased to minimize coupling of signals generated by the display panel 200 or allow a sensing pad to perform operations while no signals are being applied to the corresponding portion of an LCD panel.

Also, it is clear that emissive display devices, for example, organic light emitting diodes (OLEDs), do not need the light diffuser 230 and the light source 240, such as a backlight unit.

Although it is explained thus far that the twelve rectangles 130 are used only as the numbers of the cellular phone, the twelve rectangles 130 may be variously applied using a graphic user interface (GUI). For example, the GUI allows a user to select press buttons 1 to 9, *, 0, and # viewed on the display unit 210 when the user wants to talk over the phone. Alternatively, the user may select menus using 12 graphic icons that are viewed on the display unit 210 using the GUI.

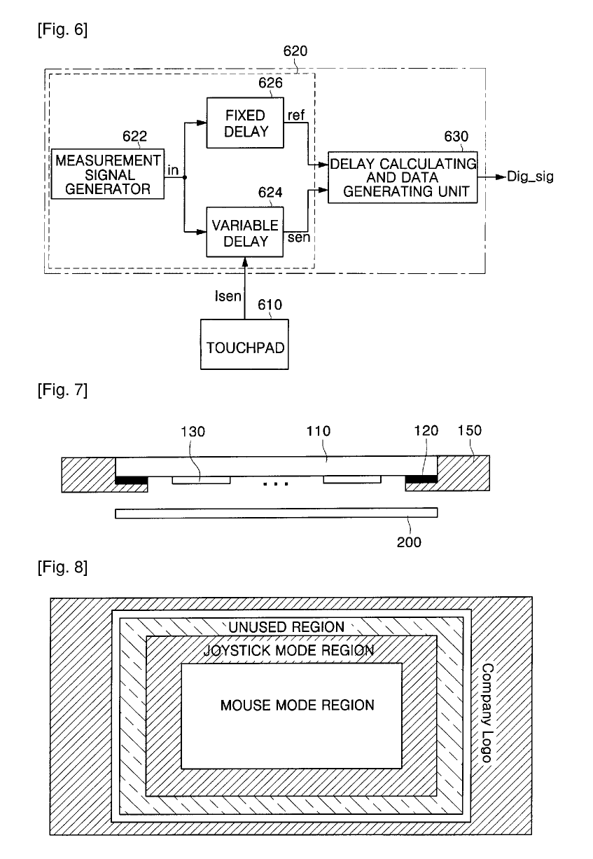

FIG. 6 is a block diagram of a digital contact controller included in the sensing unit (refer to 600 in FIG. 5). Referring to FIG. 6, the digital contact controller includes a delay variable unit 620 and a delay calculating and data generating unit 630. The delay variable unit 620 includes a measurement signal generator 622, a variable delay 624, and a fixed delay 626.

In this case, a touchpad 610 varies impedance Isen according to the intensity of external stress. Thus, the touchpad 201 may be any kind of element whose an electrostatic capacitance, an inductive impedance, or a resistance varies with the intensity of external stress.

The delay variable unit 620 generates a reference signal “ref” and a sensing signal “sen” between which there is a delay difference that varies in proportion to the impedance Isen of the touchpad 610. For this, the measurement signal generator 622 generates a measurement signal “in”, which is clocked in a predetermined time period, and applies the measurement signal “in” to each of the variable delay 624 and the fixed delay 626. The variable delay 624, which is connected to the touchpad 610, delays the measurement signal “in” according to the impedance of the variable delay 624 and the impedance Isen of the touchpad 610 and generates the sensing signal “sen”. Also, the fixed delay 626 delays the measurement signal “in” according to the impedance of the fixed delay 626 and generates the reference signal “ref”.

The delay calculating and data generating unit 630 receives the reference signal “ref” and the sensing signal “sen”, calculates a delay difference between the reference signal “ref” and the sensing signal “sen”, and generates digital data Dig_sig corresponding to the delay difference.

FIG. 7 is a cross-sectional view of a cellular phone including a touch panel in which a cover is fixed by an outer cover of the cellular phone according to another exemplary embodiment of the present invention, and FIG. 8 is a plan view of the cellular phone including the touch panel shown in FIG. 7.

Referring to FIG. 7, both edges of a cover 110 are fixed by an outer cover 150, an opaque region 120 is disposed under both the edges of the cover 110, and a plurality of electrodes 130 are disposed between the opaque regions 120. The outer cover 150 is disposed also under the opaque region 120 and fixes the opaque region 120. A display panel 200 for displaying an image is located below the outer cover 150.

Since the cover 110 is fixed by the outer cover 150, the cover 110 is bent to a different extent according to a position that is pressed when the cover 110 is contacted by a finger or an object. For example, the center of the cover 110 may be highly bent, while the edges of the cover 110 may be hardly bent. Accordingly, the cellular phone shown in FIG. 7 can not only detect states of contact but also bend the cover 110 to different extents. Therefore, the cellular phone according to the present embodiment may be constructed to perform different operations according to bending extents.

Referring to FIG. 8, which is a plan view of an example of the nonlinear structure shown in FIG. 7, the entire covers are divided into a predetermined number of regions, and electrodes are disposed on the cover. A portion of the cover which is highly bent under pressure is used in a mouse mode, while a portion of the cover which is hardly bent is used in a joystick mode. Here, a pointer is moved to a distance corresponding to a detected moving distance of a mouse in the mouse mode, and the entire screen is continuously moved to a distance corresponding to a detected moving distance of a joystick.

The foregoing operation of an electronic device using pressure may be applied to remote controllers or game input apparatuses, which use the cover as a skin type.

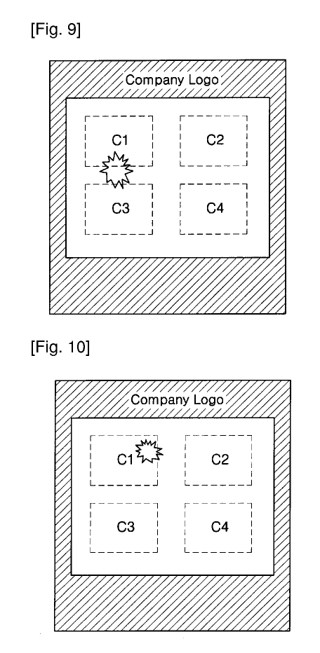

FIGS. 9 and 10 are plan views of a cellular phone including a touch panel according to yet another exemplary embodiment of the present invention, which perform different operations according to a direction in which an electrode is contacted by a finger or an object and the intensity of a pressure applied to the electrode when the electrode is contacted by the finger or object.

A sensing unit including a plurality of DCCs according to the present invention is capable of measuring increased electrostatic capacitance when electrodes having the same electrostatic capacitance in a non-contact state are contacted by the finger or object. Thus, the sensing unit can detect whether or not the electrodes are contacted by the finger or object and the direction and intensity of a pressure applied to the electrodes.

Four electrodes shown in FIG. 9 have respective electrostatic capacitances C1, C2, C3, and C4, which are the same in the non-contact state. However, when the electrodes having the electrostatic capacitances C2 and C4 are not contacted by the finger or object, the electrodes having the electrostatic capacitances C1 and C3 are contacted by the finger or object at the same time as illustrated in FIG. 9, and a higher pressure is applied to the electrode having the electrostatic capacitance C1 than to the electrode having the electrostatic capacitance C3, ΔC1>ΔC3>ΔC2=ΔC4. Here, capacitances are made of distance between electrodes 130 and display panel 200.

Assuming that the four electrodes function as direction keys, the electrode having the electrostatic capacitance C1 indicates left upward motion, the electrode having the electrostatic capacitance C2 indicates right upward motion, the electrode having the electrostatic capacitance C3 indicates left downward motion, and the electrode having the electrostatic capacitance C4 indicates right downward motion, FIG. 9 shows a case where a screen or a pointer is moved left upward at a small slope.

When only the electrode having the capacitance C1 is contacted by the finger or object as illustrated in FIG. 10, since ΔC1>ΔC2=ΔC3=ΔC4, the screen or pointer is moved left upward at a greater slope than when both the electrodes having the electrostatic capacitances C1 and C3 are contacted by the finger or object.

Although it is described thus far that four electrodes are disposed on a display panel, the present invention is not limited thereto and additional electrodes may be disposed in the remaining outer region of a cellular phone.

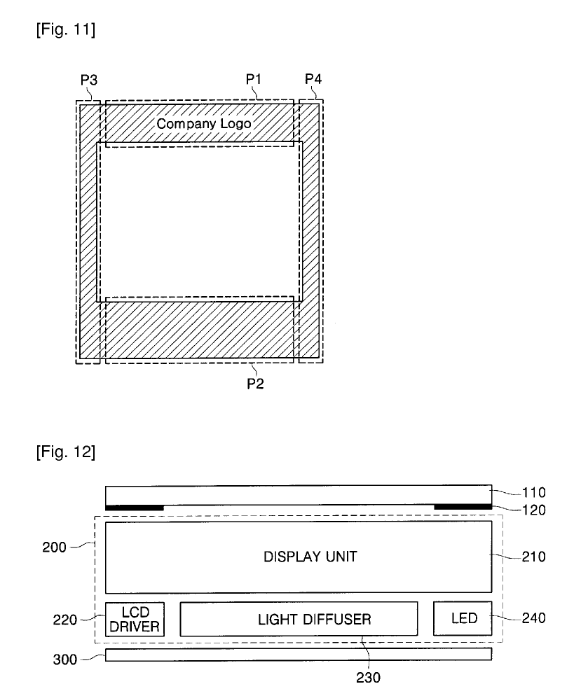

FIG. 11 is a plan view of a cellular phone including a touch panel in which electrodes are disposed in an opaque region of a cover, according to yet another exemplary embodiment of the present invention. Portions illustrated with dotted lines refer to the electrodes disposed under the opaque region.

In the present embodiment, the electrodes are disposed under the opaque region of the cover instead of disposing transparent electrodes under the cover on which an image is projected. Therefore, the electrodes may not be transparent electrodes. For instance, the electrodes shown in FIG. 11, specifically, an upper electrode P1, a lower electrode P2, a left electrode P3, and a right electrode P4 may function to indicate upward motion, downward motion, left motion, and right motion, respectively. Also, a plurality of electrodes may be disposed on each of four sides of the cover and used to enable scroll functions or disposed on any place of the cover. Thus, the electronic device of the present embodiment can be variously changed as a matter of convenience or according to design specifications.

FIG. 12 is a cross-sectional view of a cellular phone including a touch panel in which a light diffuser included in a display device is used as an electrode, according to still yet another exemplary embodiment of the present invention.

Referring to FIG. 12, a cover 110 includes an opaque region 120 disposed under both edges thereof to prevent internal units of a display panel 200 from being exposed. The display panel 200 is disposed under the opaque region 120. A circuit substrate 300 is disposed under the display panel 200 and connects the internal units of the display panel 200 to an internal circuit of a cellular phone.

The display panel 200 includes a display unit 210 disposed under the opaque region 210 to display an image, a driver 220 disposed under the display unit 210 to externally receive an image signal and drive the image signal, a light source 240 for irradiating light, and a light diffuser 230 for receiving light from the light source 240 to uniformly diffuse the light toward the display unit 210.

In the present embodiment, the light diffuser 230, which is a metal plate, is used as one electrode. Of course, it is possible that an additional electrode may be disposed under the light diffuser 230 to detect a state of contact.

The structure shown in FIG. 12 simply functions to distinguish a state of contact from a state of noncontact. Since the light diffuser 230 is disposed far away from the cover 110, it should be provided with a large area to elevate capacitive sensitivity. Also, the light diffuser 230 may be divided into one or more metal plates and use the metal plates as electrodes.

Since the structure of FIG. 12 simply distinguishes the state of contact from the state of noncontact, when a user holds a cellular phone to his or her ear to answer the phone and a distance between the cellular phone and the ear becomes close enough to detect a variation of capacitance, the cellular phone is switched from a standby mode to a receiving mode. Also, while the user is talking over the cellular phone, when the cellular phone is separated a distance from the ear, the cellular phone may detect a variation of capacitance and be muted.

Although the cellular phone is exemplarily described, the present invention may be applied to other various electronic devices including display panels.

Also, as described above, various electrodes may be used as the electrodes used in the touch panel in consideration for users' desired purpose, construction, or convenience. For example, the electrodes used in the touch panel may be transparent electrodes, opaque electrodes, semitransparent electrodes, or metal plates. While the invention has been shown and described with reference to certain exemplary embodiments thereof, it will be understood by those skilled in the art that various changes in form and details may be made therein without departing from the spirit and scope of the invention as defined by the appended claims.

1. An electronic device comprising:
a display panel for displaying an image; and
a touch panel including a cover and a plurality of electrodes adhered to the cover.

2. The electronic device according to claim 1, further comprising a sensing unit including a plurality of digital contact controllers for detecting delays caused by variations of capacitances of the electrodes to output digital data signals.

3. The electronic device according to claim 1, wherein the display panel comprises:
a display unit on which the image is displayed;
a driver for externally receiving an image signal to drive the image signal on the display unit;
a light source disposed on a rear surface of the display unit to irradiate light; and
a light diffuser for receiving the light from the light source to uniformly diffuse the light toward the display unit.

4. The electronic device according to claim 1, wherein the cover includes a plurality of nonconductive opaque regions disposed under edges thereof, and the electrodes are disposed under the opaque regions to detect states of contact.

5. The electronic device according to claim 1, wherein the electrodes adhered to the cover are interposed between the cover and the display panel.

6. The electronic device according to claim 5, wherein the electrodes adhered to the cover are aligned with the cover in a shape, position, and size corresponding to the shape, position, and size of a screen displayed on the display unit of the display panel.

7. The electronic device according to claim 6, wherein the electrodes adhered to the cover comprise transparent electrodes, opaque electrodes, or semitransparent electrodes.

8. The electronic device according to claim 3, wherein the light diffuser comprises at least one metal plate that is used as an electrode.

9. The electronic device according to claim 2, wherein the sensing unit detects whether or not the electrodes are contacted by a finger or an object and the direction and intensity of a pressure applied to the electrodes.

10. The electronic device according to claim 9, wherein the digital contact controllers detect delays caused by variations of inductances, capacitances, and resistances generated in the transparent electrodes and output digital data signals.

11. The electronic device according to claim 10, wherein each of the digital contact controllers comprises:
a delay variable unit for generating a sensing signal delayed by a delay time that varies with a reference signal having a fixed delay time and the impedance of an externally applied signal; and
a delay calculating and data generating unit for calculating a delay difference between the reference signal and the sensing signal to generate digital data corresponding to the delay difference.

12. The electronic device according to claim 11, wherein the delay variable unit comprises:
a measurement signal generator for generating a measurement signal;
a fixed delay for delaying the measurement signal by a predetermined time to generate the reference signal; and
a variable delay for varying a delay time in response to the impedance of the externally applied signal and delaying the measurement signal by the varied delay time to generate the sensing signal.

13. A method of arranging a touch panel of an electronic device including a display panel having a display unit on which an image is displayed, the method comprising:
arranging a cover on the display unit; and
arranging a plurality of electrodes on one surface of the cover.

14. The method according to claim 13, wherein the cover comprises a plurality of nonconductive opaque regions disposed under edges thereof, and the electrodes are disposed under the opaque regions.

15. The method according to claim 13, wherein the electrodes are adhered to the cover and interposed between the cover and the display panel.

16. The method according to claim 15, wherein the electrodes adhered to the cover are aligned with the cover in a shape, position, and size corresponding to the shape, position, and size of a screen displayed on the display unit of the display panel.

17. The method according to claim 16, wherein the electrodes adhered to the cover comprise transparent electrodes, opaque electrodes, or semitransparent electrodes.

18. The method according to claim 17, wherein the entire cover is divided into specific regions, and at least one of the electrodes adhered to the cover is disposed in each of the regions of the cover.
